(19) United States
(12) Patent Application Publication
(10) Pub. No.: US 2026/0287477 A1
(43) Pub. Date: Sep. 24, 2026

(54) Pollution Protected Sensor Units

(71) Applicant: BELIMO Holding AG, Hinwil (CH)

(72) Inventors: Patrick Reissner, Herrliberg (CH); Fabian Jähnig, Zürich (CH); Roman Wyss, St. Gallen (CH)

(73) Assignee: BELIMO Holding AG, Hinwil (CH)

(21) Appl. No.: 19/479,113

(22) PCT Filed: Apr. 26, 2024
(86) PCT No.: PCT/EP2024/061659

§ 371 Date: Oct. 27, 2025

(30) Foreign Application Priority Data
Apr. 28, 2023 (CH) CH000457/2023

(51) Int. Cl. G01N 1/22; G01F 1/661; G01N 15/075; G01N 15/1404; G01P 5/26

(52) U.S. Cl. CPC G01N 1/2202; G01F 1/661; G01N 1/2247; G01N 15/075; G01N 15/1404; G01P 5/26

(57) ABSTRACT

A device for monitoring a characteristic of an airflow, especially in an HVAC system, includes:
an inlet port for receiving a partial airflow (PAF) of the airflow to be monitored (AF);
a particle separator arranged downstream the inlet port and configured for separating particles (P) having a particle size and/or particle weight above of a given threshold out of the partial airflow;
a measurement cell located downstream the particle separator and including a fluid flow channel with a channel inlet and channel outlet for guiding the partial air flow (PAF) from the channel inlet through the measurement cell to the channel outlet;
a sensor unit configured for measuring at least one characteristic of the partial airflow (PAF) when passing through the fluid flow channel; and
an outlet port for discharging the partial airflow after having passed the measurement cell.

### TECHNICAL FIELD

The invention relates to a device for monitoring a characteristic of an airflow, especially in an HVAC system. Furthermore, the invention is concerned with an air duct for guiding an airflow, especially an air duct of a HVAC system, comprising the device for monitoring a characteristic of an airflow. Other aspects of the present invention are directed to a method for monitoring a characteristic of an airflow, especially for monitoring of particulate matter in an air flow, and the use of the device for monitoring a characteristic of an air flow, especially the air flow in a duct, in particular in a HVAC system.

### Background Art

Sensors for measuring characteristic of an air flow are widely used for many different applications, such as, for example, in household appliances or in HVAC systems (HVAC=Heating, Ventilation and Air Conditioning).

Although sensors currently available on the market often are designed for several years of use, the functionality of the sensors is impaired by airborne contaminants over time. Household appliances and products usually do not require stringent requirements for longevity and measurement precision, since, usually, (i) the products do not need to last more than 5 years, (ii) they can be easily replaced and (iii) they do not have to fulfill any safety standards or health-related aspects.

However, the requirements for HVAC systems are much more demanding. When compared with an ordinary room, pollution in air ducts is far more pronounced, in particular due to dust accumulation in ducts and HVAC components. In particular, particles, fibers, smoke, oily substances as well as other contaminants from the environment can be deposited on or close to sensor units and decrease the measurement accuracy of the sensors and/or their lifetime, as measurement components become soiled.

In this regard, U.S. Pat. No. 7,669,457 B2 (Honeywell) describes an aspirated smoke detector, which includes an ambient air flow separation element in combination with a smoke sensing chamber. The flow separation element can be an active or a passive element. Separated ambient air, carrying relatively small particles can flow into the sensing chamber while ambient air carrying relatively large particulate matter is excluded from the sensing chamber. However, the detector is rather complex in design and requires special aspirators, such as e.g. a fan or a blower, in order to pull air into the detector. Mechanical parts, such as aspirators, are disadvantageous with respect to service life.

Thus, there is still a need to develop improved solutions that do not have the disadvantages mentioned above or have them to a lesser extent.

### SUMMARY OF THE INVENTION

It is the object of the invention to provide an improved device and method for monitoring a characteristic of an airflow, especially in an HVAC system. Preferably, the device should provide a long service life with low maintenance effort. In particular, impairment of the device by airborne contaminants shall be reduced or prevented. Furthermore, the device should be as cost effective as possible.

The solution of the invention is specified by the features of independent claims 1, 24 and 25. Further preferred embodiments are subject of dependent claims and/or outlined throughout the following description.

Thus, a first aspect of the invention is directed to a device for monitoring a characteristic of an airflow, especially in an HVAC system, the device comprising:
a) An inlet port for receiving a partial airflow of the airflow to be monitored;
b) A particle separator arranged downstream the inlet port and configured for separating particles having a particle size and/or particle weight above of a given threshold out of the partial airflow;
c) A measurement cell located downstream the particle separator and comprising a fluid flow channel with a channel inlet and channel outlet for guiding the partial air flow from the channel inlet through the measurement cell to the channel outlet;
d) A sensor unit that is configured for measuring at least one characteristic of the partial airflow passing through the fluid flow channel;
e) An outlet port for discharging the partial airflow after having passed the measurement cell.

Surprisingly, it was found that with the inventive approach it is possible to provide a device for monitoring a characteristic of an airflow with high measurement accuracy and long service life. Thereby, the device can be configured such that airborne contaminants are effectively directed away from critical measurement components.

In particular, the use of a particle separator downstream of the inlet port effectively prevents physical soiling of critical components within the sensor, allowing it to be used for demanding safety applications.

Furthermore, the device can be provided without any critical mechanical components, such as e.g. fans or blowers, thus further saving costs and elongating the lifetime of the overall system.

A further advantage is that the inventive design is highly flexible and allows for providing devices capable of measuring various characteristics of an airflow, such as e.g. particle properties, flow rates, proportions of carbon dioxide, proportions of volatile organic compounds, humidity, pressure and/or temperature of the partial air flow passing through the fluid flow channel.

In particular, in order to reduce or avoid dirt deposition, the flow of the partial air flow in the fluid flow channel should be kept as laminar as possible. Furthermore, an increased velocity of the partial air flow may further reduce or avoid dirt deposition.

Thus, in particular, the device is configured such that under intended operation conditions the flow of the partial air flow in the fluid flow channel is laminar.

Especially, the fluid flow channel is configured such that for a velocity of the partial air flow in the fluid flow channel of 0.001-10 m/s, the flow is laminar and/or such that the Reynolds number is smaller than 2300 and/or such that the Dean number is smaller than 60.

Configurations of the fluid flow channel as described above allows to effectively reduce soiling of critical components of the sensor unit.

In particular, the fluid flow channel has a length of 5-500 mm and/or the fluid flow channel, in a direction perpendicular to the length, has a maximum width of 0.5-50 mm.

A ratio of the length of the fluid flow channel between the channel inlet and the channel outlet to the maximum width of the fluid flow channel preferably is 5-20, especially 8-12, in particular 10.

In a special embodiment, the fluid flow channel between the inlet and the outlet has a constant cross-section section. However, for special applications, another configuration might be preferable.

In particular, the fluid flow channel, in a section between the channel inlet and the channel outlet, or along the whole length between the channel inlet and the channel outlet, is curved, especially curved along a circular line.

These geometrical conditions are beneficial for obtaining laminar flow within the fluid flow channel and for reducing soiling of critical components of the sensor unit.

According to a preferred embodiment, the device further comprises an air pickup device to be inserted in the airflow to be monitored, whereby the pickup device is configured for collecting the partial airflow at a first location in the airflow to be monitored and guiding the partial air flow to the inlet port. A pickup device can e.g. be a body protruding into the airflow to be monitored and having one or more deflector(s), fluid conduit(s) and/or fluid channel(s) to direct a partial airflow to the inlet port.

Preferably, the air pickup device additionally is configured for reintroducing the partial airflow being discharged from the outlet port at a second location, the second location preferably being arranged downstream the first location in the airflow to be monitored.

With such a setup, a differential pressure between the first and second location in the air flow to be monitored can be used to make the partial air flow move through the fluid flow channel. Thereby, no aspirator, e.g. fan or blower, is required. Nevertheless, an aspirator may be used, e.g. for special applications.

Preferably the air pickup device comprises an elongate body with at least one first fluid conduit with at least one opening for taking up the partial air flow at an upstream side of the elongate body, whereby the at least one first fluid conduit is in fluid communication with the inlet port. The elongate body for example has a cylindrical cross section, e.g. a circular, an elliptical or a trapezoidal cross section.

Especially, the elongate body of the air pickup device comprises at least one second fluid conduit with at least one opening for discharging the partial air flow downstream the at least one first fluid conduit, whereby the at least one second fluid conduit is in fluid communication with the outlet port.

In particular, the at least one first fluid conduit and/or the at least one second fluid conduit comprises or consists of a groove in the outer surface, the groove preferably running along a straight line, in particular running in parallel to a longitudinal axis of the elongate body.

According to a preferred embodiment, the air pickup device is configured for creating a differential pressure of 0.1-100 Pa when being placed in the airflow to be monitored having a flow velocity from 0.25-10 m/s, especially 1-5 m/s. These flow conditions are typical in a HVAC duct and the pressure difference of 0.1-100 Pa is suitable to make a partial air flow move through the fluid flow channel.

In another preferred embodiment, the pickup device comprises a filter element for pre-filtering the partial air flow upstream the inlet port. With such a filter element, coarse airborne particles and/or droplets can be filtered off, e.g. in order to avoid blocking of the inlet port and/or preventing soiling of components of the device downstream the inlet port. However, in another preferred embodiment, the pickup device does not comprise a filter element.

Especially, the sensor unit is configured for measuring at least one particle property, a flow rate, a proportion of carbon dioxide, a proportion of volatile organic compounds, a humidity, a pressure and/or a temperature of the partial air flow passing through the fluid flow channel.

Thus, the sensor unit may comprise one or more sensors which are configured to measure one or more of the above mentioned characteristics. Several sensors may be integrally formed in a single unit and/or be provided as separate sensors.

Additionally, the sensor unit may comprise a processing unit, e.g. a microprocessor, for processing signals. Signal of the sensor unit may alternatively or in addition be processed with a processing unit of the overall device and/or with an external processing unit. According to a special embodiment, the device or the sensor unit is configured for measuring a particle concentration of the particles in the partial airflow passing through the fluid flow channel. The particle concentration in particular is the particle number concentration and/or the particle mass concentration.

Especially preferred, the sensor unit is configured for:
counting the number of and/or sizing the particles in the partial airflow passing through the fluid flow channel;
and, optionally, measuring a flow rate and/or velocity of the partial air flow in the fluid flow channel.

Such a setup allows for determining a particle and/or fine dust concentration in the air flow to be monitored. For example, fine dust sensors can be used for air quality monitoring as well as for early fire detection in fire dampers. Thus, such a configuration contributes to the safety and comfort in buildings.

Especially, the sensor unit comprises an optical particle detector, especially based on a light scattering method. Such detectors are highly precise and allow for a reliable determination of particle counts.

Typically, a particle detector works by drawing a partial air flow through a beam of light and detecting the light scattered off the particles entrained in the air flow. These particles scatter light in proportion to their size, composition, shape and other physical properties.

Lenses, mirrors, or other light collection techniques typically are used to increase the portion of the scattered light, which is focused for example onto a photodetector. The photodetector converts this scattered light into an electrical signal. This electrical signal is typically a pulse whose amplitude is related to the amount of scattered light reaching the photodetector and whose duration is typically related to the transit time of the particle through the beam of light. Thus, from the photodetector output and associated circuitry information about the number and size of particles in a sampled volume of air can be determined.

Especially, the sensor unit comprises an optical particle detector comprising:
a light source, especially a laser light source and/or a light emitting diode, which in particular is configured for producing a beam of light that at least partially passes through the partial air flow; and
a photodetector, which is configured for detecting light scattered off the particles entrained in the partial air flow.

Highly preferred, the optical particle detector further comprises a beam dump, especially arranged in a direction of the beam of light emitted by the light source. The beam dump can be used for removing detrimental light backscattered from components of the measurement cell, especially from components of the sensor unit. In particular, the beam dump is configured to reduce or prevent direct or indirect reflexions (first and second reflexions) of the beam of light emitted by the light source.

A beam dump is meant to be an optical element that absorbs the light emitted by the light source, typically by using a material with strong absorption and low reflectance. Especially, in the present case, the beam dump is configured as a hollow element, which in particular is covered with a material with strong absorption and low reflectance at the inside.

Especially, the design of the fluid flow channel and/or the sensor unit is such that, at least in the region of the sensor unit or throughout the whole fluid flow channel, there is a predominantly laminar flow in the fluid flow channel.

In particular, the fluid flow channel and the sensor unit are configured such that a fluid-conducting boundary wall of the fluid flow channel, at least in the region of the sensor unit or throughout the whole fluid flow channel, is designed stepless and/or continuously.

Especially, the design of the fluid flow channel, the light source, the photodetector and/or the beam dump is such that, at least in the region of the sensor unit or throughout the whole fluid flow channel, there is a predominantly laminar flow in the fluid flow channel. This helps to reduce or prevent accumulation of dirt particles in the fluid flow channel, the light source, the photodetector and/or the beam dump.

Overall, this helps to reduce or avoid turbulences in the partial air flow and to keep away dirt particles from critical sensor components, especially from a beam dump (see below), the light source and the photodetector. This is important because dirt particles adsorbed on or in such components, e.g. inside the beam dump, may distort the particle measurement, e.g. by scattering light which might reach the photodetector via further reflexions. For example, particles deposited in the region of the sensor unit, e.g. due to vibrations, may erroneously be detected as airborne particles in the partial air flow and distort the particle measurement. This can e.g. lead to misoperation of a HVAC systems or cause false alarms.

Especially, the beam dump in particular is configured to reduce or prevent direct or indirect reflexions of the beam of light caused by particles eventually captured inside the beam dump. Direct or indirect reflexions can also be called first and second reflexions.

In particular, the beam dump and/or photodetector is/are configured and/or arranged such that there is no direct visual contact between the photodetector and particles eventually captured inside the beam dump, especially the beam trap.

This and/or the avoidance of first and second reflexions of trapped particles can be achieved for example by a narrowed light inlet opening of the beam dump. Such configurations further help to reduce erroneous measurements caused by moving and/or vibrating particles in the beam dump.

Further preferred a light absorbing cross section and/or the light inlet opening of the beam dump is larger than a cross section of the beam of light, especially twice as large, in particular the light absorbing cross section has a size equal to 0.5-1.5 times, especially 0.9-1.1 times, the cross section of the fluid flow channel. Large beam dump have shown to reduce soiling problems.

In particular, the light source, especially the laser light source and/or the light emitting diode, is configured to emit light with one wavelength or to emit light with at least two different wavelengths, especially in the visible light spectrum. In particular the light source is configured for emitting red and/or blue light. A combination of more than one wavelength(s) will help to improve the overall detection precision. Red and blue light for example turned out to be highly beneficial with respect to particle detection under usual conditions in HVAC systems.

The optical particle detector in particular is configured such that a direction of the beam of light produced with the light source is perpendicular to a direction of detection of the photodetector. Put differently, the light source is arranged orthogonal to the photodetector. This means that the photodetector is configured to detect light scattered in a direction perpendicular to the direction of the beam of light emitted by the light source.

Especially, the optical particle detector is configured such that a focus of the beam of light, especially the focus of the laser light source, is located at the intersection of the direction of the beam of light and the detection direction.

In particular, the light source and/or the photodetector and/or the beam dump is/are arranged such that a light emitting area of the light source and/or a light detecting area of the photodetector and/or a light inlet opening of the beam dump is not located in a bottom area of the measurement cell or a bottom area of the fluid flow channel. Put differently, the light emitting area of the light source and/or the light detecting area of the photodetector and/or the light inlet opening of the beam dump preferably is located in a top area and/or side area of the measurement cell or the fluid flow channel. This will further reduce soiling problems since dirt deposit can be reduced.

“Bottom”/“lower” and “top”/“upper”/“above” in particular are with respect to the direction of gravitation in the intended configuration of installation of the inventive device.

Especially, the light source and the beam dump are arranged in a common plane, especially a common horizontal plane, at opposite sides of the fluid flow channel, and the photodetector is located above this common plane. Thereby, the beam of light in particular is emitted in a horizontal direction. With such a configuration, none of the light source, the beam dump and the photodetector is located in a bottom area which is prone to dirt deposits.

In another possible embodiment, the light source and the photodetector can be arranged on a first side of the fluid flow channel and the beam dump is arranged at an opposite side of the fluid flow channel.

With respect to the direction of gravitation in an intended mounting direction of the inventive device, in particular, the light source and the photodetector can for example be arranged at an upper side of the fluid flow channel and the beam dump is located at a lower side of the fluid flow channel. Alternatively, the light source and the photodetector can be arranged at a lower side of the fluid flow channel and the beam dump is located at an upper side of the fluid flow channel. This second alternative has the advantage that beam dump, which is especially prone to dirt deposit, is less exposed to dirt deposits. The separator preferably is a selected from a vortex separator, an impactor and/or a particle trap. A particle trap is for example an extension in the flow path, e.g. upstream the channel inlet of the fluid flow channel, for trapping particles.

Highly preferred, the separator is a particle trap. Particle traps are rather simple in design and hardly require maintenance.

Especially, the separator is configured such that with respect to a fluid path in the separator, there is no straight line of sight between an upstream end of the separator and the downstream end of the separator.

For example, the separator is configured such that a direction of the airflow after having passed the separator differs by at least 30°, especially at least 60°, in particular at least 80°, for example by 90°, from a direction of the airflow when entering the separator.

With such configurations of the separator, particles can be separated out of the partial air flow particularly effectively. However, other configurations are possible as well.

Especially, a threshold of the separator in terms of particle size is between 2-20 μm, especially the threshold is 2-10 μm, in particular the threshold is 3-4 μm.

In the present context, for non-spherical particles, the particle size is meant to be the equivalent spherical diameter of the particle. Put differently, the particle size is the diameter of a sphere of equivalent geometric volume-based particle size that equals the diameter of a sphere that has the same volume as the given particle. For spherical particles, the equivalent spherical diameter equals the spherical diameter of the particle.

In particular, the device does not comprise a flow-generating device, especially the device does not comprise a fan and/or a blower, to create an airflow in the fluid flow channel. Flow-generating devices usually comprise mechanical components, which may break down and/or require maintenance. Thus, omitting such kind of devices reduces costs and elongates the lifetime of the overall system.

Instead of a flow-generating device, the air flow can be generated by pressure differences between the inlet port and the outlet port, especially with an air pickup device as described above.

Therefore, according to an especially preferred embodiment, the inventive device does not comprise movable parts and/or the device is configured such that the flow of the partial air flow through the fluid flow channel of the measurement cell is exclusively affected by the airflow to be monitored.

Further preferred, the device is configured such that the partial airflow downstream the inlet port, does not flow through a filter, especially the separator is a filterless separator.

Especially preferred, between the inlet port and the outlet there is no filter. However, this does not exclude the presence of a filter in the pickup device.

In the present context, a filter is meant to be an element for physical separation of airborne solid and/or liquid matter by using a filter medium whereby air is passed through the filter medium in order to filter off solid and/or liquid matter.

In another preferred embodiment, the device as a whole is a filterless device.

Avoiding or reducing the number of filters in the inventive device helps to improve the lifetime of the overall system and to reduce maintenance effort. Nevertheless, a filter can be present for special applications and/or as a pre-filter stage in the pickup device, as described above.

In a further preferred embodiment, the fluid flow channel, measurement cell and/or the separator are integrally formed within an adapter, especially the adapter is present in the form of a monolithic body. In particular, both, the measurement cell and the separator are integrally formed within the adapter. The adapter in particular is made from polymeric material, especially an elastomeric material, e.g. rubber. Especially, in this case, the measurement cell and/or the separator is/are present in the form of hollow spaces within the adapter or the monolithic element, respectively.

Such kind of adapters can e.g. be produced by casting, especially casting of polymeric material.

In particular, the adapter can be combined with a frame element, especially made from a material that, in terms of modulus of elasticity, is less elastic than the adapter. For example, the frame element is configured to accommodate and/or at least partially surround the adapter. The frame element may in particular be fastened to the adapter in a form- and/or force-fit manner.

The frame element may be used to mechanically stabilize the adapter during the assembling process, e.g. for better gripping by automatic assembling devices, and/or when mounted in the inventive device.

In particular, the adapter comprises one or more connection elements, e.g. openings and/or stubs, for connecting the adapter to corresponding connection elements of the inlet port, the outlet port and/or the sensor unit.

Highly preferred, the adapter is configured such that it can be connected to the inlet port, the outlet port and/or the sensor unit by plugging on and/or plugging in the respective connection element of the adapter on and/or in a corresponding connection element of the inlet port, the outlet port and/or the sensor unit. Thereby, preferably, the connection elements of the adapter and the respective connection elements of the inlet port, the outlet port and/or the sensor unit are interconnected in a form- and/or force-fit manner. This greatly facilitates the assembling process since it can be implemented in an automatic manner.

This can e.g. be achieved by providing an adapter made essentially of an elastomeric material and appropriately dimensioning the corresponding connection elements of the inlet port, the outlet port and/or the sensor unit, such that a clamping and sealing effect is achieved.

Further preferred, the sensor unit is placed on a board, especially a printed circuit board, and the adapter, in particular accommodated in the frame element, is configured to be plugged on and/or plugged in a connection element of the sensor unit.

Especially, the adapter, in particular accommodated in the frame element, is additionally fixed on the board, especially the printed circuit board, in a form- and/or force-fit manner, e.g. with an additional connection element, e.g. a latching element. The additional connection element may for example be a mounting element, e.g. a pin and/or a spacer, for mounting the board within a housing of the inventive device.

Such kind of adapters make it possible to dispense with individual elements, such as pipes, tubes and channels, or to reduce their number. Also, due to the reduced number of parts, longevity will be improved and assembling of the inventive device will be facilitated.

In a special embodiment, the device further comprises a further separator, which is arranged downstream the channel outlet of the fluid flow channel and upstream the outlet port. Thereby, preferably, the separator and the further separator are identical in design.

Further preferred, the air pickup device is configured such that the section of the air pickup device that is configured for collecting the partial airflow at a first location in the airflow to be monitored and guiding the partial air flow to the inlet port is identical in design with the section of the air pickup device that is configured for reintroducing the partial airflow being discharged from the outlet port at a second location.

Especially preferred, the inventive device is symmetrical in design with respect to the path of the partial air flow from the inlet port to the outlet port, especially such that the inlet port can serve as the outlet port and vice versa.

Likewise, an inventive device comprising an air pickup device is symmetrical in design with respect to the path of the partial air flow from the first location to the second location.

Such symmetric embodiments reduce the risk of faults during assembly since it does not matter which side of the device is oriented upstream and which side is oriented downstream in an air flow to be monitored.

In a special embodiment, the inventive device comprises: a printed circuit board with a sensor unit and an adapter as described above in a common housing, whereby the housing comprises an inlet port and an outlet port that are connected to the adapter. Further ports may be present in the housing to pass through power, control and/or data lines. In particular, the inlet port and the outlet port are provided on a port unit that is configured to be clipped in a cutout of the housing. The printed circuit board in particular is mounted in the housing with a mounting element, e.g. a pin and/or a spacer, as described above.

Such configurations of the inventive device can directly be attached to components of HVAC system, infrastructure elements and the like, for monitoring a characteristic of an airflow.

A further aspect of the present invention is directed to an air duct for guiding an airflow, especially an air duct of a HVAC system, comprising a device as described above.

Especially, the device used with the air duct comprises an air pickup device as described above, whereby, preferably, the air pickup device protrudes into the duct section through which the airflow can pass and, preferably, the measurement cell is located outside the air duct.

Further preferred, the air pickup device is configured such that the first location is located upstream in an intended flow direction of the airflow in the duct and the second location is located downstream in an intended flow direction of the air flow in the duct.

Another aspect of the present invention is directed to a method of monitoring a characteristic of an airflow, especially for monitoring of particulate matter in an air flow, in particular in a HVAC system, with a device as described above or with the air duct described
a) Providing an air flow, especially in an air duct;
b) Receiving a partial air flow of the air flow through the inlet port;
c) Separating particles having a particle size and/or particle weight above of a given threshold out of the partial air flow;
d) Guiding the partial air flow from the channel inlet of the fluid flow channel through the measurement cell to the channel outlet;
e) Measuring at least one characteristic of an air flow, especially a particle concentration, of the partial air flow passing through the fluid flow channel;
f) Discharging the partial airflow after having passed the measurement cell through the outlet port.

Thereby, preferably, the partial airflow is collected with an air pickup device as described above at a first location in the airflow to be monitored and guided to the inlet port and, optionally, the partial airflow being discharged from the outlet port is reintroduced into the airflow to be monitored at a second location, the second location preferably being arranged downstream the first location in the airflow to be monitored.

In particular, a velocity of the air flow to be monitored, especially the air flow in the air duct, is from 0.25-10 m/s, especially 1-5 m/s and/or a pressure difference between the first location and the second location in the air flow to be monitored is 0.1-100 Pa.

A still further aspect of the present invention is directed to the use of a device as described above for monitoring a characteristic of an air flow, especially the air flow in a duct, in particular in a HVAC system.

Thus, another aspect of the present invention is directed to a HVAC system comprising a device or a duct as described above.

Other advantageous embodiments and combinations of features result from the detailed description below and the entirety of the claims.

### BRIEF DESCRIPTION OF DRAWINGS

The drawings used to explain the embodiments show:

FIG. 1 A device for monitoring a particle concentration suitable for use in a HVAC system;

FIG. 2 The device of FIG. 1 with an additional air pickup device that is inserted in an airflow AF to be monitored;

FIG. 3 A cross section of the air pickup device along line A-A of FIG. 2;

FIG. 4 The device with the air pickup device of FIG. 2 mounted in a duct of a HVAC system;

FIG. 5 An exploded view of an arrangement with an adapter with inlet and outlet openings;

FIG. 6 The arrangement of FIG. 5 in assembled state;

FIG. 7 The arrangement of FIG. 6 mounted in a housing comprises a port unit that can be attached to the housing in order to provide the inlet port and the outlet port;

FIG. 8 A detailed cross sectional view of a sensor unit of a further embodiment.

In the figures, the same components are given the same reference symbols.

### EXEMPLARY EMBODIMENTS

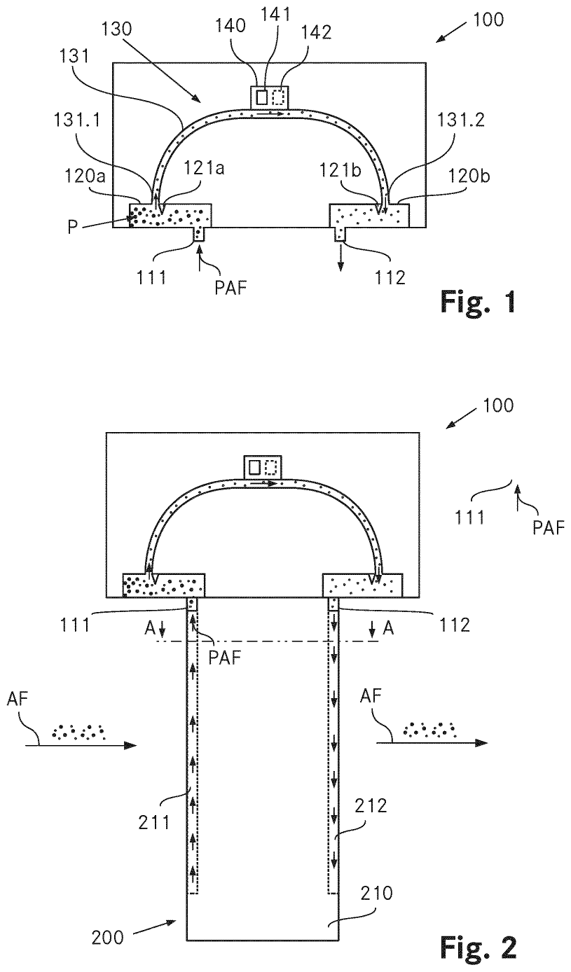

FIG. 1 shows a device 100 for monitoring a particle concentration (=a characteristic of an airflow) suitable for use in a HVAC system. The device comprises an inlet port 111 for receiving a partial airflow PAF of an airflow to be monitored (not shown in FIG. 1; cf. FIG. 2). Downstream the inlet port 111, a particle trap 120a (=particle separator) is arranged and configured for separating particles P having a particle size and/or particle weight above of a given threshold (indicated by large dark points) out of the partial airflow PAF. A protrusion 121a is placed in particle trap 120a to form an obstacle that defines a fluid path in the separator 120a with no straight line of sight between an upstream end of the separator 120a and the downstream end of the separator 120a.

A measurement cell 130 is located downstream the particle separator 120a and comprises a fluid flow channel 131 with a channel inlet 131.1 and channel outlet 131.2 for guiding the partial air flow PAF from the channel inlet 131.1 through the measurement cell 130 to the channel outlet 131.2. The fluid flow channel 131 consists of a first part that is curved along a circular line, a second and straight part and a third part and that is curved along a circular line.

For example, the fluid flow channel 131 has a length of 100 mm and, in a direction perpendicular to the length, a constant width of e.g. 3 mm. Between the channel inlet 131.1 and the outlet 131.2, the fluid flow channel 131 in this example has a constant cross-section section.

In the second and straight part of the fluid flow channel 131, a sensor unit 140 that is configured for measuring a particle concentration of the particles in the partial airflow PAF passing through the fluid flow channel 131 is arranged. The sensor unit 140 for example comprises a first and optical sensor 141 that is configured for counting the number of and/or sizing the particles in the partial airflow PAF passing through the fluid flow channel 131 and, optionally, a second sensor 142 that is configured for measuring a flow rate and/or velocity of the partial air flow PAF in the fluid flow channel 131. The two sensors 141, 142 may be integrally formed in a single unit. Alternatively, they may be provided as separate sensors.

Downstream the channel outlet 131.2 of the fluid flow channel 131, a further particle trap 120b (=further separator) with a further protrusion 121b is arranged. The further particle trap 120b is identical in design with the particle trap 120a.

Downstream the further particle trap 120b, an outlet port 112 for discharging the partial airflow PAF after having passed the measurement cell 130 is arranged.

The device shown in FIG. 1 is symmetrical in design with respect to the path of the partial air flow PAF from the inlet port 111 to the outlet port 112. Therefore, the inlet port 111 could serve as the outlet port 112 and vice versa.

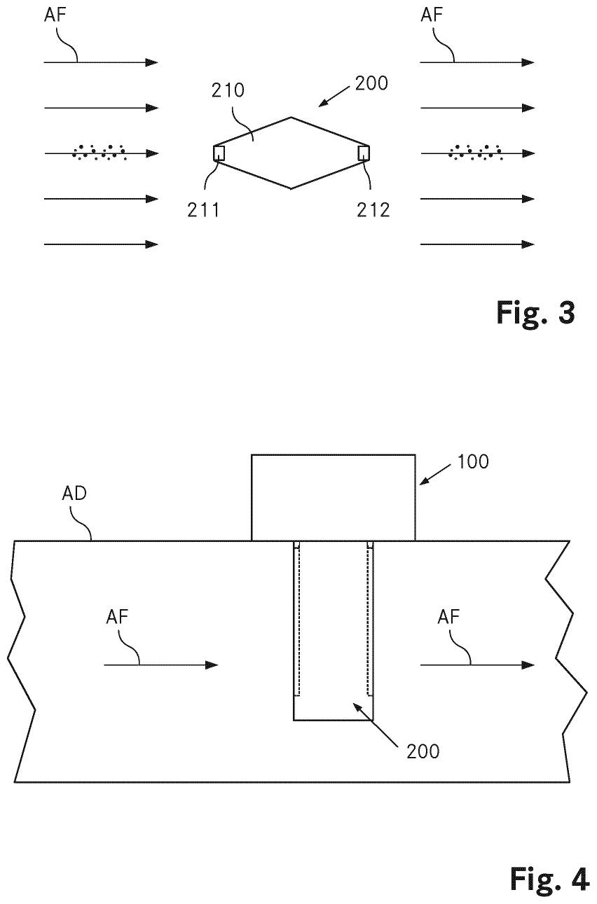

FIG. 2 shows the device 100 of FIG. 1 with an additional air pickup device 200 that is inserted in an airflow AF to be monitored. The pickup device 200 consists of an elongate body 210 with trapezoidal cross section as shown in FIG. 3 (=cross section along line A-A of FIG. 2)

The elongate body 210 comprises a first groove 211 in the outer surface (=first fluid conduit) for taking up the partial air flow PAF at an upstream side of the elongate body 210 (left side of air pickup device 200 in FIG. 2) and guiding the partial air flow to the inlet port 111. Opposite the first groove 211, there is a second groove 212 (=second fluid conduit; right side of air pickup device 200 in FIG. 2) for reintroducing the partial air flow PAF discharged from the outlet port 112 downstream the first groove 211 back into the airflow AF.

The air pickup device 200 is symmetrical in design with respect to the path of the partial air flow PAF from the first location to the second location. Thus, in principle, it does not matter which side of the air pickup device 200 is oriented upstream and which side is oriented downstream in the air flow to be monitored AF.

FIG. 3 shows a cross section of the elongated body 210 along line A-A of FIG. 2. Thereby, the first groove 211 is arranged upstream in the air flow to be monitored AF whereas the second groove is arranged downstream in the air flow to be monitored AF. This arrangement causes a pressure difference between the first and the second groove and thus between the inlet port 111 and the outlet port 112.

This pressure difference causes the partial air flow PAF extracted from the air flow to be monitored AF to move from the inlet port 111 through the measurement cell 130 to the outlet port 112 and back into the air flow to be monitored AF. Thereby, no flow generating device, such as a blower or fan, is required.

FIG. 4 shows a typical application of the device 100 with the air pickup device 200 of FIG. 2 mounted in a duct AD of a HVAC system.

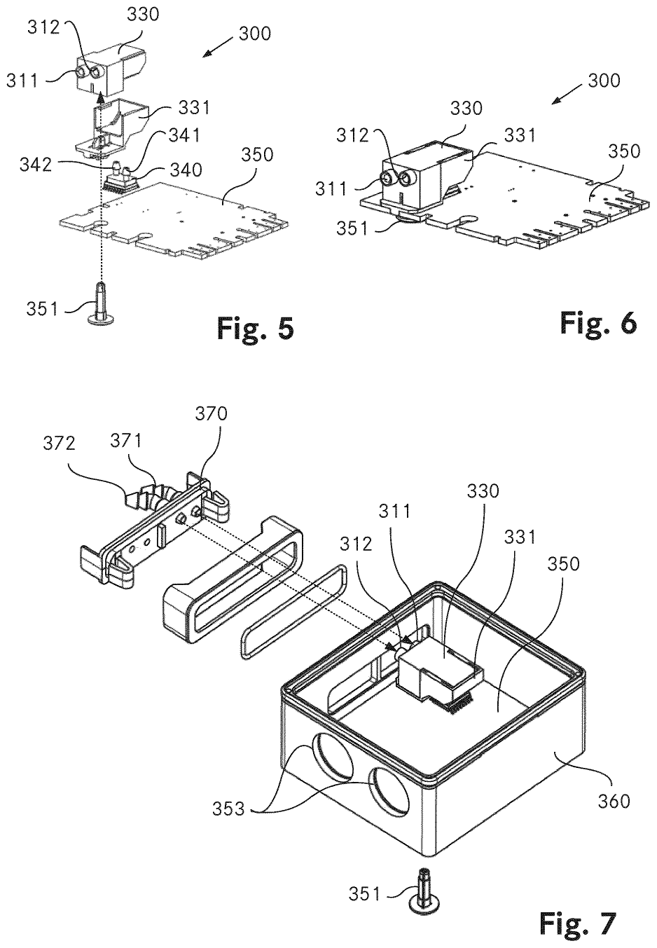

FIG. 5 shows an exploded view of an arrangement 300 with an adapter 330 comprising a fluid flow channel and separators (not shown in FIG. 5 but similar to the ones shown in FIG. 1) as well as an inlet opening 311 and an outlet opening 312. Measurement cell, separators and the openings 311, 312 are integrally formed within the adapter 330. Furthermore, at the bottom side, the adapter 330 comprises openings for connecting the adapter to a sensor unit 340, e.g. a differential pressure sensor or the like, via connection elements 341, 342 (stubs) of the sensor unit 340. The adapter 330 is present in the form of a monolithic body and consists for example of an elastomeric material, e.g. rubber.

The adapter 330 is configured such that it can be connected to the inlet port (not shown in FIG. 5), the outlet port (not shown in FIG. 5) and the sensor unit 340 by plugging on and/or plugging in the respective connection element of the adapter 330 on and/or in a corresponding connection element of the inlet port, the outlet port and/or the sensor unit 340.

Additionally, a frame element 331 is provided for accommodating and partially surrounding the adapter 330. The frame element 331 is for example made of a material that, in terms of modulus of elasticity, is less elastic than the adapter 330. The frame element 331 is configured for mechanically stabilizing the adapter 330 during the assembling process and when being mounted in an inventive device.

Furthermore, a printed circuit board 350 is provided for mounting the sensor unit 340 and the adapter 330 accommodated in the frame element 331. A latching pin 351 is provided for fixing the adapter 330 through the printed circuit board 350.

FIG. 6 shows the arrangement 300 of FIG. 5 in assembled state. Thereby the connection elements of the adapter 330 (openings in the bottom) and the respective connection elements of the sensor unit 340 (connection elements 341, 342) are interconnected in a form- and force-fit manner. This is achieved in this example by appropriately dimensioning the corresponding connection elements of the sensor unit 340, such that a clamping and sealing effect is achieved. Additionally the latching pin 351 is accommodated in a further opening of the adapter 330 (not shown) for additionally fixing the adapter 330 on the printed circuit board 350 in a secure manner.

FIG. 7 shows the arrangement of FIG. 6 mounted in a housing 360. The housing 360 additionally comprises a port unit 370 that can be attached to the housing 360 by clipping in order to provide the inlet port 371 and the outlet port 372. A connection element of the inlet port 371 is plugged in the inlet opening 311, whereas a connection element of the outlet port 372 is plugged in the outlet opening 312 of the respective adapters 330 in a form- and force-fit manner.

Additionally, the housing 360 comprises further ports 353 to pass through power, control and/or data lines.

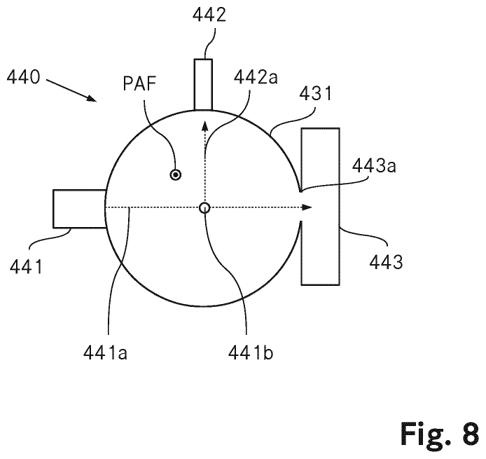

FIG. 8 shows a detailed view of a sensor unit 440 of a further embodiment. Specifically, FIG. 8 shows a cross section of a fluid flow channel 431 in the region of the sensor unit 440 whereby, the partial air flow PAF flows out of the image plane.

At the left side of channel 431, a laser light source 441 is arranged that emits a beam of light 441a, (e.g. red and/or blue light) in horizontal direction. At the opposite side of channel 431, a beam trap 443 with a narrowed opening 443 is located. The beam trap is used for removing detrimental light backscattered from components of the fluid flow channel 431.

At an upper side of the fluid flow channel 431, above a common plane defined by the laser light source 441 and the beam dump 443, a photodetector 422 is arranged. A detection direction 442a of the photodetector is perpendicular to the beam of light 441a. The photodetector 442 is configured for detecting light scattered off the particles entrained in the partial air flow (PAF).

A focus 441b of the beam of light 441a is located at the intersection of the direction of the beam of light 441b and the detection direction 442a.

It will be appreciated by those skilled in the art that the present invention can be embodied in other specific forms without departing from the spirit or essential characteristics thereof. The presently disclosed embodiments are therefore considered in all respects to be illustrative and not restricted.

Especially, instead of or in addition to a sensor 141 for counting the number of and/or sizing the particles, another sensor can be used, e.g. a CO₂ sensor, a humidity sensor, a VOC sensor and the like.

Furthermore, the particle traps 120a, 120b can be replaced by other separators, e.g. vortex separators. Also, the separator 120b at the downstream region can be omitted.

The air pickup device 200 can have another cross section, e.g. a circular or elliptical cross section. Also, the groove 212 may be omitted. In addition of or instead of grooves 211, 212, closed channels with openings can be foreseen.

In groove 211, e.g. right in front of the inlet port 111, an additional filter element may be present for pre-filtering the partial air flow.

In summary, it is to be noted that the invention provides highly beneficial device for monitoring a characteristic of an airflow, especially in an HVAC system, such as e.g. particle properties, flow rates, proportions of carbon dioxide, proportions of volatile organic compounds, humidity, pressure and/or a temperature. Thereby, the inventive devices are in particular long-lasting and low-maintenance.

1. A device for monitoring at least one characteristic of an airflow, the device comprising:
a) an inlet port for receiving a partial airflow of the airflow to be monitored;
b) a particle separator arranged downstream the inlet port and configured for separating particles having a particle size and/or particle weight above of a given threshold out of the partial airflow;
c) a measurement cell located downstream the particle separator and comprising a fluid flow channel with a channel inlet and a channel outlet for guiding the partial air flow from the channel inlet through the measurement cell to the channel outlet;
d) a sensor unit configured for measuring the at least one characteristic of the partial airflow when passing through the fluid flow channel; and
e) an outlet port for discharging the partial airflow after having passed the measurement cell.

2. The device according to claim 1, whereby a ratio of a length of the fluid flow channel between the channel inlet and the channel outlet to a maximum width of the fluid flow channel is 5-20.

3. The device according to claim 1, whereby the fluid flow channel, in a section between the channel inlet and the channel outlet, or along a whole length between the channel inlet and the channel outlet, is curved.

4. The device according to claim 1, further comprising an air pickup device configured to be inserted in the airflow to be monitored, wherein the pickup device is configured for collecting the partial airflow at a first location in the airflow to be monitored and guiding the partial air flow to the inlet port.

5. The device according to claim 4, whereby the air pickup device additionally is configured for reintroducing the partial airflow being discharged from the outlet port at a second location, the second location arranged downstream the first location in the airflow to be monitored.

6. The device according to claim 4, wherein the air pickup device comprises an elongate body with at least one first fluid conduit with at least one opening for taking up the partial air flow at an upstream side of the elongate body, wherein the at least one first fluid conduit is in fluid communication with the inlet port.

7. The device according to claim 6, wherein the air pickup device further comprises at least one second fluid conduit with at least one opening for discharging the partial air flow downstream the at least one first fluid conduit, wherein the at least one second fluid conduit is in fluid communication with the outlet port.

8. The device according to claim 6 or 7, wherein the at least one first fluid conduit and/or the at least one second fluid conduit comprises a groove in an outer surface.

9. The device according to claim 4, wherein the air pickup device is configured for creating a differential pressure of 0.1-100 Pa when placed in the airflow to be monitored having a flow velocity from 0.25-10 m/s.

10. The device according to claim 4, wherein the pickup device further comprises a filter element for pre-filtering the partial air flow upstream the inlet port.

11. (canceled)

12. The device according to claim 1, wherein sensor unit is configured for determining a particle concentration, a particle number concentration, or a particle mass concentration.

13. The device according to claim 12, wherein the sensor unit further configured for:
counting the number of and/or sizing the particles in the partial airflow passing through the fluid flow channel;
and measuring a flow rate and/or velocity of the partial air flow in the fluid flow channel; and
wherein the sensor unit comprises an optical particle detector comprising:
a light source configured for producing a beam of light that at least partially passes through the partial air flow; and
a photodetector configured for detecting light scattered off the particles entrained in the partial air flow.

14. (canceled)

15. The device according to claim 13, wherein the optical particle detector further comprises a beam dump arranged in a direction of the beam of light emitted by the light source for removing detrimental light backscattered from components of measurement cell.

16. The device according to claim 1, wherein the fluid flow channel and/or the sensor unit are configured such that, at least in the region of the sensor unit or throughout the whole fluid flow channel, there is a predominantly laminar flow in the fluid flow channel such that particles are kept away from the beam dump, the light source, and/or the photodetector.

17. The device according to claim 1, wherein the fluid flow channel and the sensor unit are configured such that a fluid-conducting boundary wall of the fluid flow channel, at least in the region of the sensor unit or throughout the whole fluid flow channel, is stepless and/or continuously such that particles are kept away from the beam dump, the light source, and/or the photodetector.

18. (canceled)

19. The device according to claim 13, wherein the optical particle detector is configured such that a direction of the beam of light produced with the light source is perpendicular to a direction of detection of the photodetector.

20. (canceled)

21. (canceled)

22. (canceled)

23. The device according to claim 1, wherein the fluid flow channel is configured such that for a velocity of the partial air flow in the fluid flow channel of 0.001-10 m/s, the flow is laminar and/or such that the Reynolds number is smaller than 2300 and/or such that the Dean number is smaller than 60.

24. (canceled)

25. (canceled)

26. (canceled)

27. The device according to claim 1, wherein the fluid flow channel measurement cell and/or the separator are integrally formed within an adapter in the form of a monolithic element; and
wherein the adapter is configured to be connected to the inlet port, the outlet port and/or the sensor unit by plugging on and/or plugging in a connection element of the adapter on and/or in a corresponding connection element of the inlet port, the outlet port and/or the sensor unit

28. (canceled)

29. (canceled)

30. (canceled)

31. A method for monitoring a characteristic of an airflow with the device according to claim 1, comprising the steps of:
a) providing an air flow;
b) receiving a partial air flow of the air flow through the inlet port;
c) separating particles having a particle size and/or particle weight above of a given threshold out of the partial air flow;
d) guiding the partial air flow from the channel inlet of the fluid flow channel through the measurement cell to the channel outlet;
e) measuring at least one characteristic of an air flow of the partial air flow passing through the fluid flow channel; and
f) discharging the partial airflow after having passed the measurement cell through the outlet port
wherein the partial airflow is collected with an air pickup device at a first location in the airflow to be monitored and guided to the inlet port and the partial airflow being discharged from the outlet port is reintroduced into the airflow to be monitored at a second location, the second location being arranged downstream the first location in the airflow to be monitored; and
wherein the velocity of the air flow to be monitored is from 0.25-10 m/s and/or a pressure difference between the first location and the second location in the air flow to be monitored is 0.1-100 Pa.

32. (canceled)

33. (canceled)

34. (canceled)
